(19) United States
(12) Patent Application Publication
(10) Pub. No.: US 2008/0097921 A1
(43) Pub. Date: Apr. 24, 2008

(54) DIGITAL DISTRIBUTION MANAGEMENT SYSTEM AND CONTENTS DISTRIBUTION MANAGEMENT METHOD USING THE SAME

(76) Inventors: Soo Hyung Kim, Daejeon (KR); Jae Seung Lee, Seoul (KR); Ki Young Moon, Daejeon (KR); Kyo Il Chung, Daejeon (KR); Sung Won Sohn, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/867,102

(22) Filed: Oct. 4, 2007

(30) Foreign Application Priority Data
Oct. 23, 2006 (KR) 10-2006-0103159

(51) Int. Cl. G06Q 30/00; G06F 17/00; H04L 9/14

(52) U.S. Cl. 705/53; 705/59

(57) ABSTRACT

A digital distribution management system and a contents distribution management method using the same are provided. The system is formed of a contents-user, a broker, a contents-owner, and a contents distributor. The broker receives a contents use fee from the contents-user, transmits a contract document for contents use to the contents-user, pays a loyalty to a contents-owner, pays a distribution fee to the contents distributor, and makes a contract for contents use. The contents-owner transmits use rights, i.e., Service Release (SR) information on corresponding contents of a proper contents-user making a contents use contract to the contents distributor and receives a corresponding loyalty through a broker. The contents distributor receives the SR information from the contents-owner, transmits the contents and a license on the contents information so that the proper contents-user can use the corresponding contents, and receives a corresponding distribution fee through the broker.

### CLAIM OF PRIORITY

This application claims the benefit of Korean Patent Application No. 2006-0103159 filed on Oct. 23, 2006 in the Korean Intellectual Property Office, the disclosure of which is incorporated herein by reference.

### BACKGROUND OF THE INVENTION

1. Field of the Invention

The present invention relates to a digital distribution management system and a contents distribution management method using the same.

2. Description of the Related Art

As digitalization of contents such as movies, books, music and games has become easier and a network infrastructure for contents distribution has been sufficiently built, these contents have been increasingly used for commercial purpose. Accordingly, a demand for a digital rights management system (DRM) has increased in order to safely manage digital rights for related contents. Accordingly, various license distribution methods have been increased.

Conventionally, contents and licenses were distributed by a large distributor with predetermined software related to many servers for easy access of users such as Apple, Microsoft, and mobile communication companies in charge of contents distribution according to a centralized method. The centralized large distributors provide an exclusive contents format and software for contents application of a corresponding format such as iTunes and Windows Media player. Also, the centralized large distributors participate in all procedures, which are required when the user uses the contents, including packaging, distributing, billing and license issuing of the contents. Accordingly, contents-owners are only allowed to limitedly participate in comparison with the contents distributor, and it causes a problem that the contents-owners should depend on only information provided by the distributor in order to grasp a present state that their own contents are used. Although contents have great worth, the original contents are required to be exposed to a distributor.

It is preferred that the contents-owners directly manage and distribute a license required for using the contents in order to clarify the right of loyalty claim. However, it is difficult that the owners of a small quantity of contents perform diverse business processes related to the contents distribution. It is also difficult to provide a device and software in which many users can use the contents while easily accessing to a license issuance device and receiving the license.

Accordingly, there is a demand for open and decentralized DRM environment, in which owners and distributors of diverse scales can participate through a common framework to use the contents and easily accept requirements change due to business model change, and which is applicable in a network such as peer-to-peer.

### SUMMARY OF THE INVENTION

The present invention has been made to solve the foregoing problems of the prior art and therefore an aspect of the present invention is to provide a digital management system and a contents distribution management method for allowing a content owner to have rights for managing license distribution so as to clearly insist the own rights, for assigning the right for releasing license to a contents provider in order to smoothly interact with contents-users and various business models while preventing the rights of the contents-owner from being infringed, and for preventing unpaid contents from being unlawfully used while allowing user's terminals to freely use paid contents (fair use).

According to an aspect of the invention, the invention provides a digital rights management system. The digital rights management system includes a contents-user including a terminal capable of using corresponding contents; a broker for receiving a contents use fee from the contents-user, transmitting a contract document for contents use to the contents-user, paying a loyalty to a contents-owner, paying a distribution fee to the contents distributor and making a contract for contents use; a contents-owner for transmitting use rights, i.e., Service Release (SR), information on corresponding contents of a proper contents-user making a contents use contract to the contents distributor and receiving a corresponding loyalty through a broker; and a contents distributor for receiving SR information from the contents-owner, transmitting the contents and a license on the contents information so that the proper contents-user can use the corresponding contents, and receiving a corresponding distribution fee through the broker.

According to another aspect of the invention for realizing the object, there is provided a contents distribution method. The method includes the steps of: paying a contents use fee to a broker by a contents-user and making a contract for contents use; transmitting SR information on corresponding contents of a proper contents-user making a contract from a contents-owner to a contents distributor; transmitting license information including the SR from the contents distributor to the contents-user; and using the contents based on encoded contents, license information and a contract document by the contents-user.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is block diagram illustrating a digital distribution management system according to an exemplary embodiment of the present invention;

FIG. 2 is a flowchart illustrating the step of paying a contents use fee to a broker by a contents-user and making a contract for contents use that the contents-user pays the contents use fee to a broker and makes a contract for contents use in a contents distribution management method according to an exemplary embodiment of the present invention;

FIG. 3 is a block diagram illustrating a contract document for contents use which is used to the contents distribution method according to an exemplary embodiment of the present invention;

FIG. 4 is a flowchart illustrating the step of transmitting the Service Release (SR) information of the contents-user to a contents distributor to manage the contents distribution according to an exemplary embodiment of the present invention;

FIG. 5 is a block diagram illustrating a terminal corresponding to the user in a digital distribution management system according to an exemplary embodiment of the present invention;

FIG. 6 is a flowchart illustrating the steps that the contents-user receives a license from the contents distributor and uses encoded contents to distribute the contents based on the digital distribution management system according to an exemplary embodiment of the present invention; and

FIG. 7 is a block diagram illustrating the license used in the contents distribution method using the digital distribution management system according to an exemplary embodiment of the present invention.

### DETAILED DESCRIPTION OF THE PREFERRED EMBODIMENT

Exemplary embodiments of the present invention will now be described in detail with reference to the accompanying drawings. Also, the same drawing codes will be used for the parts that similarly function and operate overall in the drawings.

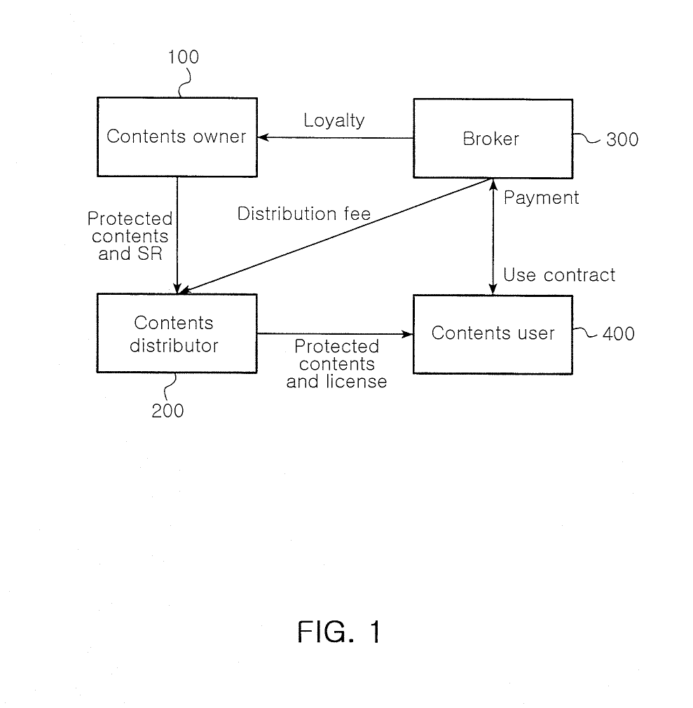

FIG. 1 is block diagram illustrating a digital distribution management system according to an exemplary embodiment of the present invention.

Referring to FIG. 1, the digital distribution management system according to the present embodiment includes a contents-owner 100, a contents distributor 200, a broker 300 and a contents-user 400. The contents-owner 100, the contents distributor 200 and the broker 300 are constitutional elements for forming the digital distribution management system. It is preferred that the digital distribution management system has a server including a communication means for transmitting/receiving data between other devices, a storage for storing the data, and a control means for managing an entire device.

The contents-owner 100 is the one who has proprietary rights for contents or the one to which the proprietary rights are committed. The contents-owner 100 provides use rights, i.e., Service Release (SR), to the contents-user 400 intending to use the contents and receives a corresponding loyalty license fee. The contents-owner 100 forms SR information to provide the SR to the contents-user 400 and transmits the information on the SR to the contents distributor 200.

The contents distributor 200 receives information on the SR from the contents-owner 100 and transmits the contents and license information on the contents to the proper contents-user 400 to use the corresponding contents. A plurality of contents distributors 200 may exist and provide a method and a device so that the users can easily receive the contents and the license on the contents, thereby receiving the corresponding distribution fee from the contents-user 400 through the broker 300.

The broker 300 provides a method and a device that the user can pay the use fee on the contents including loyalty, distribution fee, and broker commission. Also, the broker 300 distributes a part of the use fee to the contents-owner and the distributor.

The contents-user 400 downloads the license of paid contents and the encoded contents from the contents distributor to diverse devices of the contents-user 400.

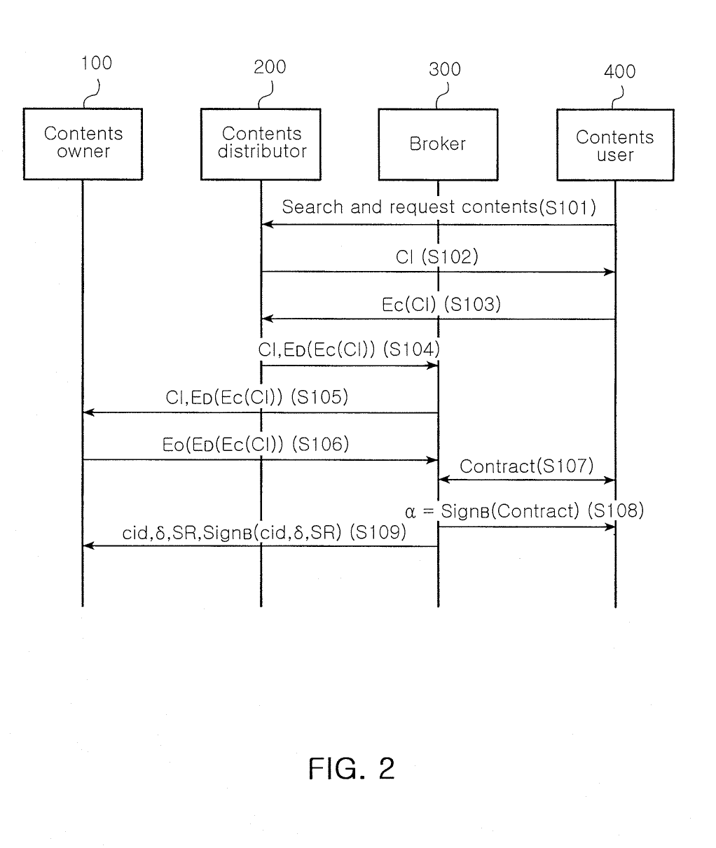

Referring to FIG. 2 to FIG. 7, a contents distribution management method using the digital distribution management system according to the present embodiment and the function and the operation of each constitutional element of the digital distribution management system will be described in detail.

It is preferred that the contents distribution management method according to the present embodiment further includes a step (not shown) that the contents-owner 100 transmits corresponding contents to the contents distributor 200 before a step of making a contract for contents use, which includes a procedure that the contents-user 400 pays a contents use fee to the broker 300.

The contents-owner 100 creates a couple of contents-owner encoding keys O_{public}/Oₚᵣᵢᵥₐₜₑ and calculates a contents encoding key (CK) where CK=Eₒ(CI) encoding a contents information including contents identification (ID) and contents-owner information, a transform value of the contents information through a hash function, and a value prepared for creating an encoding key, more than one selected from which are called CI, by a personal encoding key Oₚᵣᵢᵥₐₜₑ of the contents-owner.

Subsequently, the contents-owner 100 encodes the contents based on the calculated contents encoding key CK. In order to safely transmit the contents according to the present embodiment to the contents-user 400, it is preferred that the encoding function and the decoding function used by the contents-user 400 are disclosed to all participants of the digital distribution management system according to the present embodiment. It is also preferred that the encoding and decoding functions have a commutative characteristic. The contents-owner 100 may transform original contents into a contents format requested by the distributor, if necessary, before encoding the contents.

Subsequently, the contents-owner 100 includes the encoded contents and the CI, packages information required for distribution and use, and transmits the information to the contents distributor 200. The packaged contents may be transmitted to the user at various time points according to business models of the contents distributor 200.

The contents distribution method according to the present embodiment includes: paying a contents use fee to a broker by a contents-user and making a contract for contents use; transmitting SR information on corresponding contents of a proper contents-user making a contract from a contents-owner to a contents distributor; transmitting license information including the SR from the contents distributor to the contents-user; and using the contents based on encoded contents, license information and a contract document by the contents-user.

According to the contents distribution method, all participants can acquire desired properties. That is, the contents-owner, the contents distributor and the contents-user can acquire loyalty, a distribution fee and contents, respectively.

FIG. 2 is a flowchart illustrating the step of paying a contents use fee to a broker by a contents-user and making a contract for contents use that the contents-user pays the contents use fee to the broker and makes a contract for contents use in the contents distribution management method according to an exemplary embodiment of the present invention.

The contents-user 400 searches contents through the contents distributor 200 and requests to use the contents at step S101. It is preferred to follow the order that the contents-user 400, i.e., a terminal, accesses to the contents distributor 200, i.e., a server, searches contents and requests to use the contents. The contents distributor 200 transmits the CI of corresponding contents requested by the contents-user 400 to the contents-user 400 at step S102.

The CI is contents information including contents identification (ID) and contents-owner information, a transform value of the contents information through a hash function, and a value prepared for creating an encoding key. The CI is formed by the contents-owner 100 and provided to the contents distributor 200.

The steps S101 and S102 may be omitted under assumption that the user already has packaged contents and can extract the CI in the packaged contents.

The contents-user 400 creates a couple of contents-user encoding keys C_{public}/Cₚᵣᵢᵥₐₜₑ, encodes the CI into E_{c}(CI) by a personal encoding key Cₚᵣᵢᵥₐₜₑ of the contents-user, and transmits the E_{c}(CI) to the contents distributor 200 at step S103.

The contents distributor 200 receiving the E_{c}(CI) creates a couple of contents distributor encoding keys D_{public}/Dₚᵣᵢᵥₐₜₑ, encodes the E_{c}(CI) into E_{D}(E_{C}(CI)) by a personal encoding key Dₚᵣᵢᵥₐₜₑof the contents distributor, and transmits the E_{D}(E_{C}(CI)) to a broker with the CI at step S104. The broker 300 retransmits the data transmitted from the contents distributor 200 to the contents-owner 100 at step S105.

At the step S104, the time when a couple of contents distributor encoding keys D_{public}/Dₚᵣᵢᵥₐₜₑ are created and the range where a couple of contents distributor encoding keys D_{public}/Dₚᵣᵢᵥₐₜₑ are used may be different according to the method for realizing the present embodiment. For example, even if users are different with respect to the same contents, a couple of same keys D_{public}/Dₚᵣᵢᵥₐₜₑ may be used and the data are created only in the transaction with a first user.

When the step S104 ends, a method for connecting the broker and the user is required. A method for sharing network addresses through the distributor or a method for using a uniform resource locator (URL) redirection technique can be used.

The contents-owner 100 encodes the E_{D}(E_{C}(CI)) into Eₒ(E_{D}(E_{C}(CI))) by the personal encoding key Oₚᵣᵢᵥₐₜₑ of the contents-owner, which is the key used to create the contents encoding key (CK) and transmits the Eₒ(E_{D}(E_{C}(CI))) to the broker 300 at step S106.

The broker 300 receiving Eₒ(E_{D}(E_{c}(CI))) creates a caller identification (CID) of the user, forms a contract document including the CID, the CI, Eₒ(E_{D}(E_{C}(CI))), and service release (SR) to be released to the contents-user 400 with respect to the corresponding contents, and a certificate (Certₒ) of the contents-owner, and transmits the contract document to the contents-user 400 at step S107. Accordingly, the contents-user 400 checks the contents.

The broker 300 signs the contract document and transmits the signature value to the contents-user 400. The contents-user 400 checks at step S108 whether a signature a of the broker 300 in the contract document is exact.

The broker 300 notifies to the contents-owner 100 that the contract is made. When the CID, a hash value δ: δ=h(α, Eₒ (E_{D}(E_{C}(CI))), the SR, and the signature value sign_{B}(cid, δ, SR) are transmitted, the contents-owner 100 checks the signature value of the broker 300 at step S109. The hash function h is one of cryptologically safe hash functions and can be easily used by selection of those skilled in the art among things disclosed in the art.

When the broker 300 requests to issue the SR of the contents-user 400 paying the use fee at step S109, the contents-owner 100 can prove that the SR issuance is requested based on the transmitted data signature information of the broker 300.

At the steps S108 and S109, signing and checking of the signature value is possible through a public key infrastructure (PKI) and an undeniable digital signature. It is preferred to use the PKI in a state that the contract document does not need to be notarized.

The step that the contents-user 400 pays the use fee to the broker 300 is omitted in description. The method and the step of paying the use fee may be diversified according to a pay system of the broker 300. Since the method and the step of paying the use fee are not related to the core concept of the present embodiment, it is omitted in description.

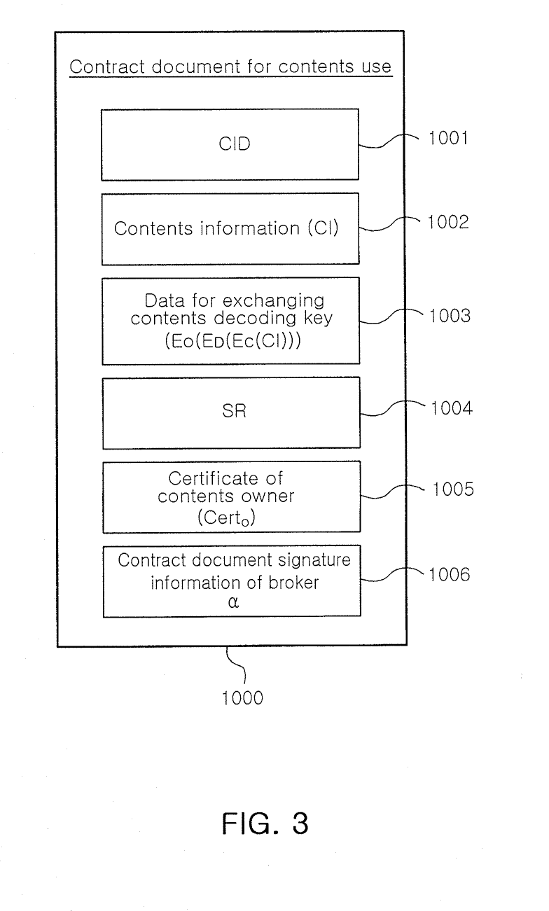

FIG. 3 is a block diagram illustrating a contract document for contents use which is used to the contents distribution method according to an exemplary embodiment of the present invention.

The contract document for contents use includes a user ID 1001, contents information 1002, data 1003 for exchanging a contents decoding key, SR 1004 to be released to the user, a certificate 1005 of a contents-owner, and contract document signature information 1006 of a broker.

The user ID 1001 is a user pseudonym created by the broker described in the step S107 of FIG. 2 and should be unique between users in the same contents.

The contents information 1002 includes the contents ID and the contents-owner information. If the contents decoding key is not changed, the contents information should be the data not to be changed.

The data 1003 for exchanging the contents decoding key is described in the step S106 of FIG. 2 and the uses of the data 1003 will be clarified in the step that the user receives the license.

The SR 1004 to be released to the contents-user 400 are used to check whether a license 2000 issued to the contents-user 400 corresponds to the contract contents.

The certificate 1005 of the contents-owner is used to verify the SR's proof 2005 to be included in the license 2000 and the uses of the certificate 1005 will be clarified in the step that the contents-user 400 decodes and uses the contents.

The contract document signature information 1006 of the broker 300 can be applied as a device for acquiring the SR for the contents that the contents-user 400 pays the use fee. For example, when a state that the contents-user 400 cannot use the contents due to the mistake of other participants such as the contents-owner 100 or the contents distributor 200 occurs, the contract document signature information 1006 of the broker 300 provides a means capable of receiving the contents use fee by notarizing the contract contents based on the broker signature information.

Additional information required for operating the DRM system may be included in a contract document 1000.

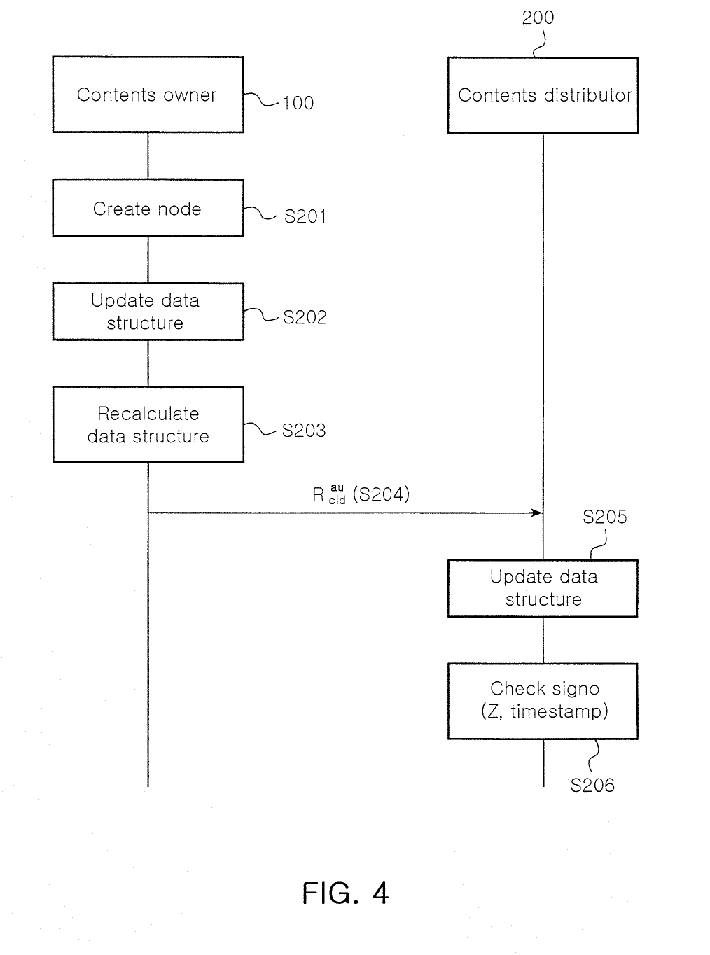

FIG. 4 is a flowchart illustrating the step of transmitting SR information on corresponding contents of a proper contents-user making a contract from a contents-owner to a contents distributor that the contents-owner 100 transmits the SR of the contents-user 400 to the contents distributor 200 to manage the contents distribution according to an exemplary embodiment of the present invention.

At the step S109 of FIG. 2, when the broker 300 notifies to the contents-owner 100 that the use contract with the contents-user is made, the contents-owner 100 defines the CID of the user newly making a contract as a name and creates a node representing a new user having {cid, δ, SR} as a value at step S201. The contents-owner 100 adds the node to a data structure, which is formed to include all nodes representing former contractors, and updates the node at step S202. The contents-owner 100 signs a digested value Z, which is calculated again to reflect the value of all nodes in the data structure adding the new node, and a timestamp as Signₒ (Z, timestamp) at step S203.

The contents-owner 100 transmits {cid, δ, SR} of the new contents-user 400, the timestamp, the signature Signₒ(Z, timestamp), and data R_{cid}^{au} including information required for updating the data structure, if necessary, to the contents distributor at step S204. The contents distributor 200 updates the data structure of the contents-owner 100 and its own data structure through the R_{cid}^{au} transmitted from the contents-owner 100 at step S205 such that the data structure of the contents-owner 100 and its own data structure can be the same. The contents distributor 200 checks the Signₒ (Z, timestamp) based on the digested value Z, which is calculated from the updated data structure, and the timestamp at step S206.

When the step S206 ends, the data structure maintained by the contents distributor 200 and a signature value of the digested value Z are authenticated data structures. Therefore, if the contents-user 400 legally makes a contract, it is possible to prove that the license is not issued to the broker 300 by the mistake of the contents-owner 100 through a proof. Also, since the users having the CID cannot create the proof for proving that the contents distributor 200 does not exist without help of the contents-owner 100, it is possible to check that the user can always receive the license and the SR authenticated by the contents-owner 100 is exactly described in the license.

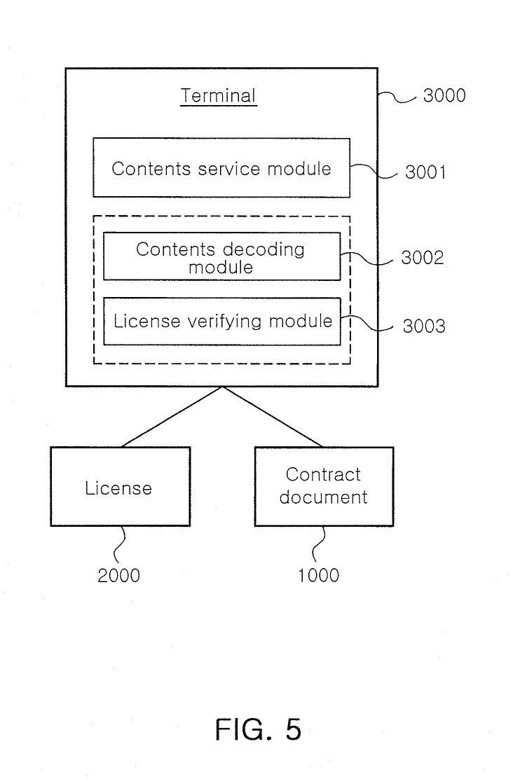

FIG. 5 is a block diagram illustrating a terminal corresponding to the user in the digital distribution management system according to an exemplary embodiment of the present invention.

Referring to FIG. 5, in the digital distribution management system according to the present embodiment, a terminal 3000 corresponding to the user includes a license verifying module 3003, a contents decoding module 3002, and a contents service module 3001.

The license verifying module 3003 verifies whether the SR that the contents-owner 100 provides to the contents-user 400 are illegally changed. Accordingly, it is preferred to check SR verification data in the license that the contents distributor 200 transmits to the contents-user 400 and a certificate of the contents-owner of the contract document for contents use. Also, the license verifying module 3003 checks whether the license is formed by the contents distributor 200. Accordingly, it is preferred to check the signature of the contents distributor 200. Also, the license verifying module 3003 checks whether the license belongs to specific hardware of the contents-user 400, i.e., whether information such as device ID of the user is included in the license.

The contents decoding module 3002 creates a contents decoding key based on C_{public} of data 2003 for exchanging the contents decoding key in the inside of the license 2000 transmitted from the contents distributor 200 and the contents-user 400, just as CK=Eₒ(CI)=D_{C}(E_{O} (E_{C}(CI))) and decodes the encoded contents.

The contents service module 3001 provides the contents decoded by the contents decoding module 3002 to the contents-user 400 within the range of SR 2004 released to the contents-user 400. It is preferred to safely realize the license verifying module 3003 and the contents decoding module 3002 to protect the license verifying module 3003 and the contents decoding module 3002 from illegal users based on methods for hardware or software, e.g., based on a safe operation environment having a temper-resistant characteristic.

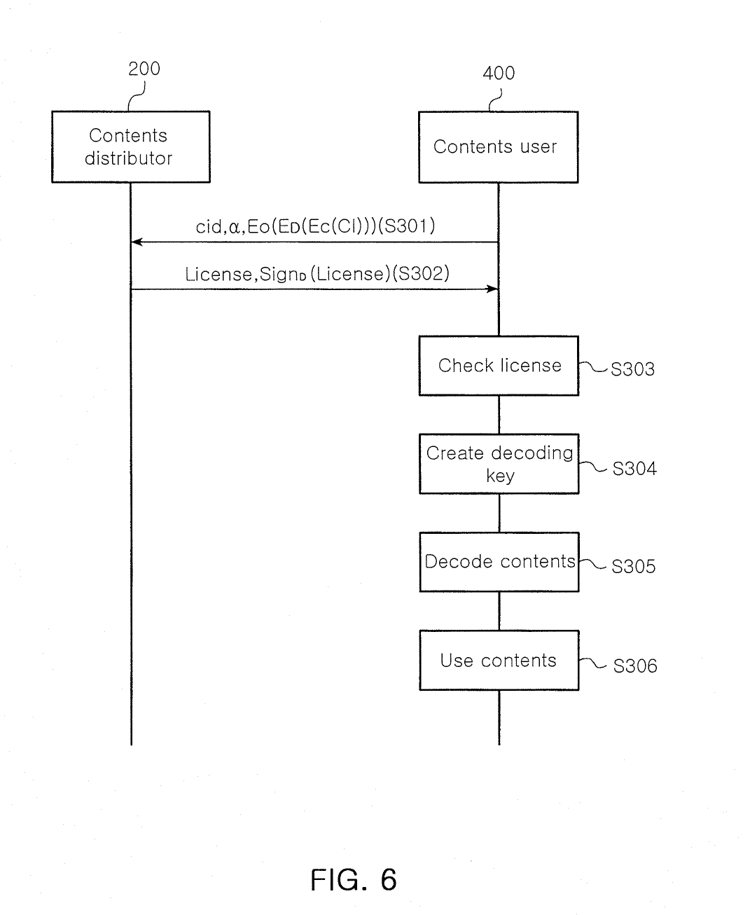

FIG. 6 is a flowchart illustrating the steps that the contents-user receives the license from the contents distributor and uses the encoded contents to distribute the contents based on the digital distribution management system according to an exemplary embodiment of the present invention.

The contents-user 400 transmits the CID, α and E_{O}(E_{D}(E_{C}(CI))) included in the contract document to the contents distributor based on the contract document transmitted from the broker 300 at step S301. The contents-user 400 transmits device ID (CDI) of the contents-user 400 to the contents distributor 200.

Subsequently, when the contents distributor 200 authenticates the contents-user 400, it is preferred to check whether a hash value h(α and E_{O}(E_{D}(E_{C}(CI)))) on the information transmitted from the contents-user 400 corresponds to δ of information {cid, δ, SR} on the proper contents-user provided by the contents-owner 100.

When the contents-user 400 is authenticated according to any method, the contents-user 400 may request issuance of the license for contents use in other device of the contents-user 400 to secure the SR. Even if the illegal user acquires information for authentication on a network, it is not possible to acquire a contents decoding key without a personal key of the contents-user 400. If the illegal user acquires the contents decoding key, it is possible to FIGure out an original source of the contents illegal distribution, i.e., the illegal user of through the proof of the CID or the SR.

When the contents-user 400 is authenticated, the proof of the SR created through the CID, the SR and the authenticated data structure, E_{O}(E_{c}(CI)) decoding E_{O}(E_{D}(E_{C}(CI))) by D_{public} the device ID (CDI), license including contents information (CI), which can be used as the requested license, and the signature value of the license are transmitted to the contents-user 400 at step S302.

The contents-user 400 checks the license through the license verifying module 3003 at step S303, creates a decoding key through the contents decoding module 3002 at step S304, decodes the encoded contents based on the created decoding key at step S305, and uses the decoded contents within the range of the permitted SR through the contents service module 3001 at step S306.

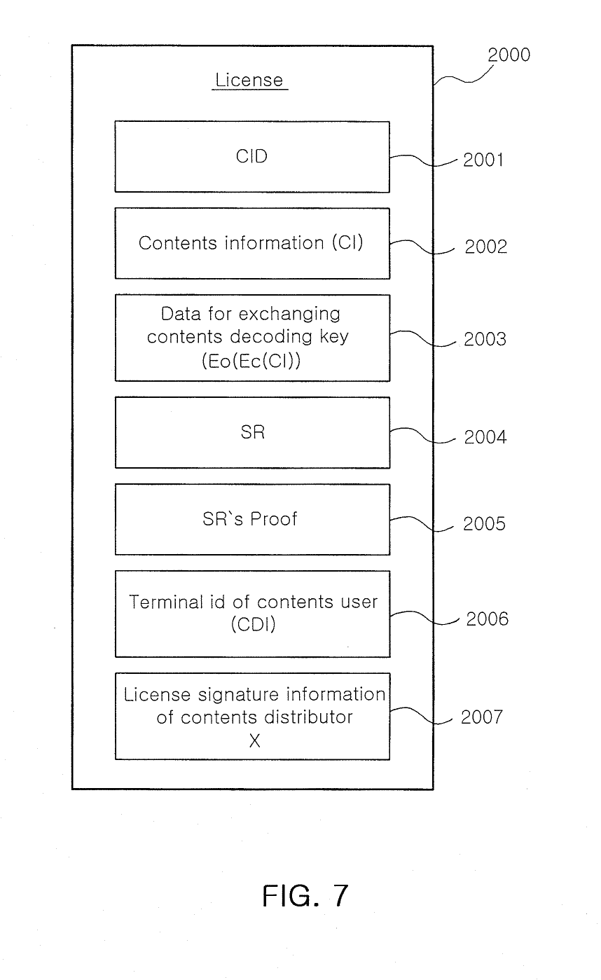

FIG. 7 is a block diagram illustrating the license used in the contents distribution method using the digital distribution management system according to an exemplary embodiment of the present invention.

Referring to FIG. 7, the license 2000 includes a user ID 2001, contents information 2002, the data 2003 for exchanging the contents decoding key, the SR 2004 released to the contents-user, the SR's proof 2005, terminal ID 2006 of the contents-user, and license signature information 2007 of the contents distributor.

The data 2003 for exchanging the contents decoding key is E_{O}(E_{C}(CI)) decoding E_{O}(E_{D}(E_{C}(CI))) by D_{public} as shown in the step S302.

The SR 2004 released to the contents-user 400 can be expressed based on diverse languages such as eXtensible Rights Markup Language (XrML), eXtensible Access Control Markup Language (XACML), and Open Digital Rights Language (ODRL).

The SR's proof 2005 includes the data created by the contents distributor 200 through the authenticated data structure and timestamp and signature information provided to the contents distributor 200 by the contents-owner 100.

The object of the terminal ID 2006 of the contents-user 400 is to limit the use of the contents to a specific terminal of the contents-user 400. The terminal ID 2006 of the contents-user 400 may include diverse unique information, which can be acquired by the terminal, or may not include diverse unique information according to the DRM business models.

The license according to the present embodiment may further include information required for operating the DRM system by selection of those skilled in the art.

As set forth above, according to exemplary embodiments of the invention, things desired by the DRM system participants such as the contents-owner, the contents distributor, the contents-user and the broker can be efficiently provided. That is, the contents-user can use the contents in diverse terminals. When the contents are illegally distributed to other people, it is possible to prevent illegal distribution of the contents by preparing the method and the device capable of checking identify of the user. Also, the contents distributor can protect the rights of the contents-owner and flexibly have the license issuance device according to its own business model.

As set forth above, according to exemplary embodiments of the invention, since personal information of the contents-user is not provided to the contents-owner or the distributor, the privacy of the contents-user can be protected. It is also possible to safely perform the license distribution process in the system where many distributors and many brokers exist by preparing the device for protecting the rights of the contents-owner and the user.

While the present invention has been shown and described in connection with the preferred embodiments, it will be apparent to those skilled in the art that modifications and variations can be made without departing from the spirit and scope of the invention as defined by the appended claims.

What is claimed is:

1. A contents distribution method according to the present embodiment, comprising:
paying a contents use fee to a broker by a contents-user and making a contract for using contents;
transmitting use rights (SR) information on corresponding contents of a proper contents-user making a contract from a contents-owner to a contents distributor;
transmitting license information including the SR from the contents distributor to the contents-user; and
using the contents based on encoded contents, license information and a contract document by the contents-user.

2. The contents distribution method according to claim 1, further comprising: encoding corresponding contents by the contents-owner and transmitting the contents to the contents distributor before the step of paying a contents use fee to a broker by a contents-user and making a contract for contents use.

3. The contents distribution method according to claim 2, wherein the step of encoding corresponding contents by the contents-owner and transmitting the contents to the contents distributor before the step of paying a contents use fee to a broker by a contents-user and making a contract for contents use includes:
creating a couple of contents-owner encoding keys O_{public}/Oₚᵣᵢᵥₐₜₑ;
encoding contents identification (ID) of the contents for transmitting the contents ID to the contents distributor, contents information including contents-owner information, a transform value of the contents information through a hash function, and contents information (CI) prepared for creating the contents encoding key by a personal encoding key Oₚᵣᵢᵥₐₜₑ of the contents-owner and calculating the contents encoding key;
encoding the contents based on the calculated contents encoding key;
packaging the encoded contents, the CI and the information required for distribution and uses; and
transmitting the packaged data to the contents distributor.

4. The contents distribution method according to claim 1, wherein the step of paying a contents use fee to a broker by a contents-user and making a contract for contents use includes:
creating data for exchanging the contents decoding key by cooperation of the contents-owner, the contents distributor and the contents-user; and
including the created data in a contract document for contents use.

5. The contents distribution method according to claim 1, wherein the step of paying a contents use fee to a broker by a contents-user and making a contract for contents use includes:
searching through the contents distributor by the contents-user and requesting the use of the contents;
transmitting corresponding contents information (CI) by the contents-user from the contents distributor to the contents-user;
encoding the CI by personal encoding key Cₚᵣᵢᵥₐₜₑ of the contents-user by the contents-user, just as E_{c}(CI) and transmitting the E_{c}(CI) to the contents distributor;
encoding the E_{c}(CI) by personal encoding key Dₚᵣᵢᵥₐₜₑ of the contents distributor, just as E_{D}(E_{C}(CI)) by the contents distributor receiving the E_{c}(CI), and transmitting the E_{D}(E_{C}(CI)) to the broker with the CI;
retransmitting the data that the broker receives from the contents distributor to the contents-owner;
encoding the E_{D}(E_{C}(CI)) by the contents-owner personal encoding key Oₚᵣᵢᵥₐₜₑ used for creating a contents encoding key (CK), just as Eₒ(E_{D}(E_{C}(CI))) by the contents-owner, and transmitting the Eₒ(E_{D}(E_{C}(CI))) to the broker;
after the broker creates caller identification (CID) of the user, forming a contract document including the CID, the CI, the Eₒ(E_{D}(E_{C}(CI))), SR released to the contents-user for corresponding contents (SR), and certificate Certₒ of the contents-owner, and transmitting the contract document to the contents-user;
after the broker signs the contract document and transmits the signature value to the contents-user, checking whether a signature a of the broker is exact in the contract document by the contents-user; and
when the broker notifies to the contents-owner that the contract is made, checking the signature value of the broker by the contents-owner.

6. The contents distribution method according to claim 5, wherein the contents information (CI) corresponds to a transform value of the contents information through contents information including the contents ID and the contents-owner information, and the hash function, and a value prepared to create an encoding key.

7. The contents distribution method according to claim 5, wherein the broker and the contents-user share their network addresses through the distributor, or are connected to each other based on a uniform resource locator (URL) redirection technique.

8. The contents distribution method according to claim 5, wherein a contract document for contents use which is transmitted to the contents-user as the result of the step of transmitting the contract document to the contents-user, includes:
a user pseudonym created by the broker, includes:
contents-user ID(CID) as a user pseudonym created by the broker, being unique among contents-users with the same contents;
contents information including contents-owner information;
data for exchanging a contents decoding key;
use rights to be released to the user (SR);
a certificate of the contents-owner for verifying SR's proof included in a license; and
contract document signature information of the broker for acquiring the SR for the contents, for which the contents-user pays the use fee.

9. The contents distribution method according to claim 5, wherein the step of transmitting SR information on corresponding contents of a proper contents-user making a contract from a contents-owner to a contents distributor includes:
creating a node corresponding to the contents-user who the contents-owner makes a contract for contents use;
adding the node to a data structure which includes a structure including all nodes representing former contractors and updating the node;
signing both of digested value Z, which is a value calculated to reflect a value of all nodes in the inside of the data structure where a new node is added, and timestamp;
transmitting data including information stored in the node of the contents-user, the timestamp, the signature value, and information required for updating the data structure from the contents-owner to the contents distributor;
updating the data structure of the contents-owner and its own data structure by the contents distributor through the data transmitted from the contents-owner so that the data structure of the contents-owner and its own data structure can be the same; and
checking a value calculated from the updated data structure and the signature value transmitted from the contents-owner based on the timestamp.

10. The contents distribution method according to claim 9, wherein a node corresponding to the contents-user has the contents-user ID, i.e., the CID, as a name and has {cid, δ, SR} as a value.

11. The contents distribution method according to claim 9, wherein the data structure maintained by the contents distributor and the signature value transmitted from the contents-owner are authenticated data structures.

12. The contents distribution method according to claim 1, wherein the step of transmitting license information including the SR from the contents distributor to the contents-user includes:
checking authentication information suggested by the contents-user through the contents use contract document by the contents distributor;
creating a license including SR information on the contents provided by the contents-owner, data for proving the SR and terminal ID of the contents-owner;
signing and transmitting the license to the contents-user; and
checking the signature of the contents distributor by the contents-user and verifying the license.

13. The contents distribution method according to claim 1, wherein the license transmitted to the contents-user as the performance result of the step of transmitting license information including the SR from the contents distributor to the contents-user includes:
user ID;
contents information;
data for exchanging a contents decoding key;
use rights released to the user (SR);
SR's proof including data created by the contents distributor through an authenticated data structure, the timestamp provided from the contents-owner to the contents distributor, and signature information;
user terminal ID for limiting the use of corresponding contents to a specific terminal of the contents-user; and
license signature information of the distributor.

14. The contents distribution method according to claim 1, wherein the step of using the contents based on encoded contents, license information and a contract document by the contents-user includes:
checking the SR's proof included in the license;
creating a contents decoding key based on data for exchanging the contents decoding key included in the license and a contents-user key;
decoding encoded contents through the created decoding key; and
using the decoded contents within the range of the SR permitted by the license.

15. A contents distribution management method in a server of a contents-owner in which the contents-owner receives a use fee for predetermined contents through a broker and distributes its own contents to a contents-user through a contents distributor, the method comprising:
encoding contents information (CI) of contents based on a personal encoding key of the contents-owner and creating an encoding key;
encoding corresponding contents by the created encoding key and providing the encoded contents and the CI to the contents distributor;
receiving a personal encoding key of the contents-user requesting the use of the contents and the CI sequentially encoded by the personal encoding key of the contents distributor;
requesting a contract for using contents to make by providing data for exchanging an encoding key and CI to a broker, where the data for exchanging an encoding key is CI sequentially encoded by the personal encoding key of the contents-owner used to create the encoding key, the received contents-user's personal encoding key, the contents distributor's personal encoding key;
receiving a notice that a contract was made with the corresponding contents-user from the broker; and
providing use rights of the contents-user notified that the contract is made and data for exchanging the decoding key to the contents distributor.

16. The contents distribution management method according to claim 15, wherein in the step of receiving a notice that a contract was made with the corresponding contents-user from the broker, when notifying that the contract is made, identification (ID) of the contents-user making the contract (CID), a signature of the broker, a hash function value δ of the data for exchanging the decoding key, use rights (SR), and a signature value for the CID, the hash function value δ and the SR are received.

17. The contents distribution management method according to claim 15, wherein the step of providing the SR of the contents-user notified that the contract is made and data for exchanging the decoding key to the contents distributor includes:
creating a node representing a new contents-user having the ID of the contents-user making the use contract as a name and {cid, hash function value δ, SR} as a value;
adding the created node to a data structure which includes all nodes representing former contents-users;
signing both of a value calculated to reflect a value of all nodes of the added data structure and a timestamp; and
transmitting a value {cid, a hash function value δ, SR} of the newly created node, the timestamp and the signature to the distributor.

18. A contents distribution management method in a contents distributor server where a broker distributes contents provided from a contents-owner to a contents-user making a contract, the method comprising:
receiving encoded contents and contents information (CI) from the contents-owner;
providing the CI to the contents-user requesting the contents use;
receiving the CI encoded by a personal encoding key of the contents-user from the contents-user;
re-encoding the CI encoded by the received personal key of the contents-user by a personal encoding key of the contents distributor, transmitting the personal encoding key to the broker with the CI and transmitting a contract request;
receiving use rights (SR) of the contents-user making a contract through the broker and data for exchanging a decoding key from the contents-owner and updating a data structure for managing SR information of the contents-users;
receiving a request for a license including identification (ID) of the contents-user, a signature of the broker, and data for exchanging a decoding key from the contents-user;
checking whether the received information of the contents-user corresponds to the information in the inside of the updated data structure; and
when the received information of the contents-user corresponds to the information in the inside of the updated data structure, providing a license including the ID of the corresponding contents-user, proof of the SR created through the SR and an authenticated data structure, data decoding the data for exchanging the decoding key by its own personal encoding key, the ID of a contents-user terminal, and contents information, which can be used as a corresponding license, and a signature of the contents distributor for the license to the contents-user.

19. A contents distribution management method of a broker making a use contract for contents distributed by a contents distributor instead of a contents-owner, the method comprising:
receiving contents information (CI) of contents requested to make a contract from a contents-user, and CI sequentially encoded by the contents-user's personal encoding key and the contents distributor's a personal encoding key;
transferring the received CI and contents information sequentially encoded by the contents-user's personal encoding key and contents-distributor's encoding key to a contents-owner, and requesting data for exchanging the decoding key;
receiving data, which is created by encoding contents information by the contents-user's encoding key and the contents distributor's personal encoding key and encoding the encoded contents information by a personal encoding key used to create a encoding key, as data for exchanging the decoding key;
creating identification (ID) of the contents-user and forming a contract document including the CI of the contents for contract, the received data for exchanging the decoding key, use rights (SR), and a certificate of the contents-owner;
transmitting the formed contract document to the contents-user so that the contents-user can check the formed contract document;
transmitting a signature of the broker to the contents-user when the contents-user checks the contract document; and
notifying to the contents-owner that the contract is made when the contents-user checks the signature.

20. A contents distribution management method of a contents-user, the method comprising:
encoding contents information (CI) of desired contents by a personal encoding key of the contents-user and transmitting the CI to a contents distributor;
receiving a contract document including identification (ID) of the contents-user, the CI of the contents for contract, the received data for exchanging a decoding key, use rights (SR), a certificate of a contents-owner and a signature of a broker from the broker;
transmitting the contents-user ID included in the contract document, the signature of the broker, the data for exchanging the decoding key, and user terminal ID to the contents distributor and requesting a license;
receiving the license including the ID of the corresponding contents-user, the SR, SR proof created through an authenticated data structure, data decoding the data for exchanging the decoding key by a personal encoding key of the contents distributor, ID of a contents-user terminal, and the CI, which can be used as a corresponding license, and a signature of the distributor for the license from the contents distributor;
decoding data, which decode the data for exchanging the decoding key of the license by a personal encoding key of the contents distributor, by its own personal encoding key and creating a decoding key of corresponding contents; and
decoding the corresponding contents by the created decoding key and using the contents.

21. A contents-user comprising:
a license verifying module for verifying whether use rights (SR) provided by a contents-owner are illegally changed;
a contents decoding module for creating a contents decoding key with reference to a license transmitted from a contents distributor and decoding the encoded contents; and
a contents service module for providing the decoded contents to the contents-user within the range of the use rights released to the contents-user (SR).

22. A digital rights management system comprising:
a contents-user including a terminal capable of using corresponding contents;
a broker for receiving a contents use fee from the contents-user, transmitting a contract document for contents use to the contents-user, paying a loyalty to a contents-owner, paying a distribution fee to the contents distributor and making a contract for contents use;
a contents-owner for transmitting use rights (SR) information on corresponding contents of a proper contents-user making a contents use contract to the contents distributor and receiving a corresponding loyalty through a broker; and
a contents distributor for receiving the SR information from the contents-owner, transmitting the contents and a license on the contents information so that the proper contents-user can use the corresponding contents, and receiving a corresponding distribution fee through the broker.

23. The digital rights management system according to claim 22, wherein the terminal of the contents-user includes:
a license verifying module for verifying whether the SR provided by the contents-owner are illegally changed;
a contents decoding module for creating a contents decoding key with reference to the license transmitted from the and decoding the encoded contents; and
a contents service module for providing the decoded contents to the contents-user within a range of the use rights released to the contents-user (SR).

24. The digital rights management system according to claim 22, wherein the contract document for contents use, which is transmitted from the broker to the contents-user, includes:
contents-user ID, which is a user pseudonym created by the broker and is unique between contents-users with respect to the same contents;
contents information including contents-owner information;
data for exchanging the contents decoding key;
SR to be released to the user;
a certificate of the contents-owner for verifying SR's proof to be included in the license; and
contract document signature information of the broker for acquiring the SR for the contents, for which the contents-user pays the use fee.

25. The digital rights management system according to claim 22, wherein the license that the contents distributor transmits to the contents-user includes:
user ID;
contents information;
data for exchanging the contents decoding key;
use rights released to the user (SR);
SR's proof including data created by the contents distributor through an authenticated data structure, a timestamp provided from the contents-owner to the contents distributor and signature information;
user terminal ID for limiting the use of the corresponding contents to a specific terminal of the contents-user; and
license signature information of the distributor.
